(19) United States
(12) Patent Application Publication
(10) Pub. No.: US 2016/0042328 A1
(43) Pub. Date: Feb. 11, 2016

(54) SYSTEMS AND METHODS FOR FACILITATING SHARING OF EXPENSES OVER A NETWORK

(71) Applicant: PAYPAL, INC., San Jose, CA (US)

(72) Inventors: Suresh Teckchandani, San Jose, CA (US); Deepanwita Roy, Sunnyvale, CA (US); Musaab At-Taras, San Jose, CA (US)

(21) Appl. No.: 14/918,495

(22) Filed: Oct. 20, 2015

Related U.S. Application Data
(63) Continuation of application No. 12/268,265, filed on Nov. 10, 2008.

(51) Int. Cl. G06Q 20/10; G06Q 20/40; G06Q 20/26

(52) U.S. Cl. CPC G06Q 20/10; G06Q 20/26; G06Q 20/40

(57) ABSTRACT

In accordance with one or more embodiments of the present disclosure, systems and methods for facilitating sharing of expenses over a network utilize a first component adapted to communicate with members of a user group via a client device over the network and a merchant via a merchant device over the network. The systems and methods for facilitating sharing of expenses over a network further utilize a second component adapted to receive a group transaction request from the user group, divide a payment for the group transaction request into a plurality of portions according to a number of members in the user group, separately debit the portions of the payment from one or more accounts related to each member of the user group, and provide payment to the merchant via the merchant device based on information passed with the group transaction request.

### CROSS-REFERENCE TO RELATED APPLICATION

This application is a continuation of Ser. No. 12/268,265, filed Nov. 10, 2008, all of which is incorporated herein by reference in its entirety.

### BACKGROUND

1. Technical Field

The present invention generally relates to network transactions and more particularly to facilitating sharing of expenses over a network.

2. Related Art

In electronic commerce, a user purchases and pays for products and services through electronic communications with online service providers over communication networks, such as the Internet. During the course of acquiring these products and services, the user registers with the online service provider to provide identity information and payment from an online account, such as an electronic commerce account. However, if the user is making an online purchase on behalf of a group of users, then the user alone is responsible for the payment. As such, the user is liable to collect funds from each of the other group members. This is often time-consuming and inconvenient for the user.

There are software accounting tools that provide the user with the ability to calculate each member's share for payment. However, these conventional software tools still require the user to collect funds from each of the other group members for payment. Accordingly, there exists a need to simplify the process of sharing expenses over a network.

### SUMMARY

Systems and methods disclosed herein, in accordance with one or more embodiments, facilitate sharing of expenses over a network. In one embodiment, a system includes a first component adapted to communicate with members of a user group via a client device over the network and a merchant via a merchant device over the network. The system includes a second component adapted to receive a group transaction request from the user group, divide a payment for the group transaction request into a plurality of portions according to a number of members in the user group, separately debit the portions of the payment from one or more accounts related to each member of the user group, and provide payment to the merchant via the merchant device based on information passed with the group transaction request.

In various implementations, the system includes a third component adapted to store a plurality of accounts including a group account related to the user group and a user account for each member of the user group. The group account includes group information related to the user group including a list of members of the user group, and each user account includes user information related to each member of the user group. The second component may be adapted to retrieve the group information related to the user group and the user information related to each member of the user group from the third component. The second component may be adapted to identify each member of the user group based on the retrieved group information related to the user group and the retrieved user information related to each member of the user group. The group information includes user group parameters including user identity information and user account numbers for each member of the user group, and the user group parameters include information related to the portion that each member of the user group is predetermined to contribute towards the payment for the group transaction request. The user group parameters may include identification information for verifying the identity of each member of the user group.

In accordance with another embodiment of the present disclosure, a method for facilitating sharing of expenses over a network includes communicating with at least one member of a user group via at least one client device over the network and a merchant via a merchant device over the network. The method includes receiving a group transaction request, dividing a payment for the group transaction request into a plurality of portions according to a number of members in the user group, separately debiting the portions of the payment from one or more accounts related to each member of the user group, and providing payment to the merchant via the merchant device based on information passed with the group transaction request.

These and other features and advantages of the present disclosure will be more readily apparent from the detailed description of the embodiments set forth below taken in conjunction with the accompanying drawings.

### BRIEF DESCRIPTION OF THE DRAWINGS

FIG. 1 shows a block diagram of a system configured to facilitate sharing of payments and purchases, in accordance with an embodiment of the present disclosure.

FIGS. 2A and 2B show various methods for facilitating client-side payment sharing transactions between a user group and a service provider server, in accordance with various embodiments of the present disclosure.

FIGS. 3 and 4 show various methods for facilitating a server-side payment sharing transactions between a user group and a service provider server, in accordance with various embodiments of the present disclosure.

FIG. 5 is a block diagram of a computer system suitable for implementing one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

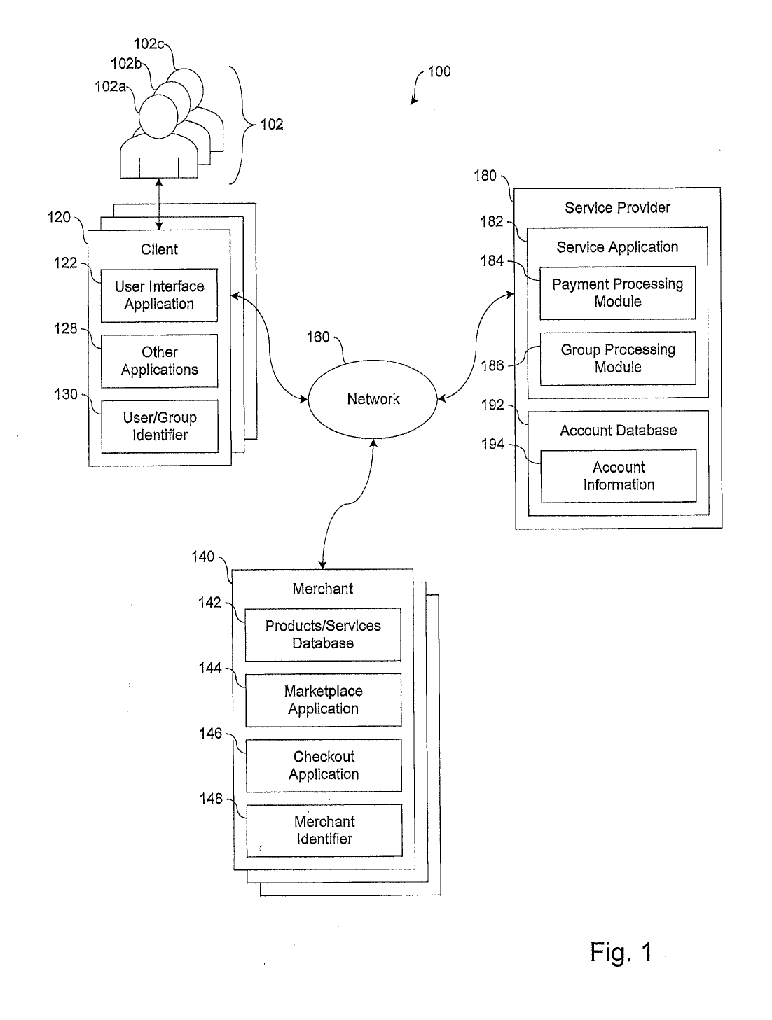

FIG. 1 shows one embodiment of a block diagram of a system 100 adapted to facilitate sharing of payments and purchases over a network 160. As shown in FIG. 1, the system 100 includes one or more client devices 120 (e.g., network computing device), one or more merchant devices 140 (e.g., network server devices), and at least one service provider device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, each of the client devices 120, merchant servers 140, and service provider 180 may be associated with a particular link (e.g., a link, such as a URL (Uniform Resource Locator) to an IP (Internet Protocol) address).

Each of the client devices 120, in various embodiments, may be implemented using any appropriate combination of hardware and/or software configured for wired and/or wireless communication over the network 160. In various examples, each of the client devices 120 may be implemented as one or more personal computers of a user group 102 (e.g., a group of users 102a, 102b, 102c) in communication with the network 160, such as the Internet. In various other examples, each of the client devices 120 may be implemented as one or more wireless telephones (e.g., cell phones), personal digital assistants (PDAs), notebook computers, and/or various other generally known types of wired and/or wireless computing devices. It should be appreciated that the one or more client devices 120 may be referred to as user devices or customer devices without departing from the scope of the present disclosure. It should also be appreciated that the user group may be referred to as a client group or customer group without departing from the scope of the present disclosure.

In one aspect, the user group 102 comprises a group of users 102a, 102b, 102c, which may be referred to as members of the user group 102. Each member of the user group 102 joins the user group 102, and the user group 102 makes purchases, makes payments, pays bills, pays invoices, etc. as a group, wherein the payment is split, shared, or divided among each member of the group according to predetermined parameters, such as a predetermined amount, portion, or percentage. Further scope related to splitting, sharing, or dividing of payments for purchases is described in greater detail herein.

Each client device 120, in one embodiment, includes a user interface application 122, which may be utilized by one or more members of the user group 102 to conduct financial transactions with the service provider server 180 over the network 160. For example, the user interface application 122 may be implemented as a group accounting application to track, manage, and store information related to shared expenses among members of the user group 102 over the network 160. In one aspect, these shared expenses may be directly and/or automatically debited from a user group account and/or each member's personal user account via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, each member of the user group 102 is able to access merchant websites via the one or more merchant servers 140 to view and select products and/or services for purchase, and each member of the user group 102 is able to purchase products and/or services from the one or more merchant servers 140 via the service provider server 180. Each member of the user group 102 may conduct financial transactions (e.g., purchase and provide payment for products and/or services) on behalf of the other members of the user group 102.

Each client device 120, in one embodiment, may include other applications 128 as may be desired in one or more embodiments to provide additional features available to each member of the user group 102. In one example, such other applications 128 may include security applications for implementing client-side security features, programmatic client applications for interfacing with appropriate application programming interfaces (APIs) over the network 160 or various other types of generally known programs and/or applications. In other examples, these other applications may interface with the user interface application for improved efficiency and convenience. For example, files, data, and/or information may be imported from accounting software (e.g., a spreadsheet application) directly into the user interface application 122 for improved tracking of expenses including purchases.

Each client device 120, in one embodiment, may include one or more user/group identifiers 130, which may be implemented, for example, as operating system registry entries, cookies associated with the user interface application 122, identifiers associated with hardware of the client device 120, or various other appropriate identifiers. The user/group identifier 130 may include attributes related to each member of the user group 102 and/or the user group 102 as a whole, such as personal information related to each user in the group (e.g., one or more user names, passwords, photograph images, biometric ids, addresses, phone numbers, etc.) and banking information (e.g., one or more banking institutions, credit card issuers, user/group account numbers, security data and information, etc.). In various implementations, the user/group identifier 130 may be passed with a user/group purchase request to the service provider server 180 via the merchant server 140, and the user/group identifier 130 may be used by the service provider server 180 to associate the user group 102 and/or each member of the user group 102 with a particular user/group account maintained by the service provider server 180, in a manner as described herein.

The one or more merchant servers 140, in various embodiments, may be maintained by one or more business entities (e.g., social networking sites, resource information sites, utility sites, real estate management sites, merchant sites, etc.) offering various products and/or services for purchase and payment, which may need registration of user/group identity information as part of offering the products and/or services to users/groups over the network 160. As such, each of the one or more merchant servers 140 may include a database 142 for identifying available products and/or services, which may be made available to the client device 120 for viewing and purchase by the user group 102.

Each of the merchant servers 140, in one embodiment, may include a marketplace application 144, which may be configured to provide information over the network 160 to the user interface application 122 of the client device 120. For example, each member of the user group 102 may interact with the marketplace application 144 through the user interface application 122 over the network 160 to search and view various products and/or services available for purchase in the database 142.

Each of the merchant servers 140, in one embodiment, may include a checkout application 146, which may be configured to facilitate online purchase transactions by the user group 102 of products and/or services identified by the marketplace application 144. As such, in one aspect, the checkout application 146 may be configured to accept payment information from the user group 102 over the network 160.

Each of the merchant servers 140, in one embodiment, may include at least one merchant identifier 148, which may be included as part of the one or more products and/or services made available for purchase so that, for example, particular products and/or service are associated with particular merchants. The merchant identifier 148 may include attributes and/or parameters related to the merchant, such as business and banking information. In various implementations, the merchant identifier 148 may be passed with a purchase request to the service provider server 180 when the user group 102 selects a product and/or service for purchase, and the merchant identifier 148 may be used by the service provider server 180 to associate particular products and/or services purchased with a particular merchant account maintained by the service provider server 180. As described in greater detail herein, the user group 102 and/or each member thereof may conduct financial transactions (e.g., purchase and provide payment for products and/or services) with each merchant server 140 via the service provider server 180 over the network 160.

In various embodiments, each of the one or more business entities having a related merchant server 140 may need to establish a merchant account with the service provider server 180. When establishing a merchant account, each of the one or more business entities may need to provide business information, such as first name, last name, address, social security number, date of birth, phone number, email address, etc., and financial information, such as banking information, merchant account information, credit card information, payment processing information, etc. Further scope is provided herein.

The service provider server 180, in one embodiment, may be maintained by an online transaction processing entity, which may provide processing for online financial and information transactions between the user group 102 and the merchant server 140. As such, the service provider server 180 includes a service application 182, which may be adapted to interact with each client device 120 and/or each merchant server 140 over the network 160 to facilitate the purchase and payment of products and/or services by the user group 102 from one or more of the merchant servers 140. In one example, the service provider server 180 may be provided by PayPal, Inc. of San Jose, Calif., USA.

The service application 182, in one embodiment, utilizes at least one of a payment processing module 184 and a group processing module 186 to process purchases and/or payments for financial transactions between the user group 102 and each of the merchant servers 140. In one aspect, the payment processing module 184 assists with resolving financial transactions through validation, delivery, and settlement. As such, the service application 182 in conjunction with the payment processing module 184 settles indebtedness between members of the user group 102 and each of the merchants 140 through which accounts may be directly and/or automatically debited and/or credited of monetary funds in a manner as accepted by the banking industry. In another aspect, the group processing module 186 assists with resolving financial transactions by identifying user accounts and retrieving information related to the identified user accounts associated with each member of the user group 102. As such, the service application 182 utilizes the group processing module 186 to facilitate the processing of financial transactions by identifying user accounts and retrieve user information related to each member of the user group 102.

The service provider server 180, in one embodiment, may be configured to maintain a plurality of user, user group, and merchant accounts in an account database 192, each of which may include account information 194 associated with individual users (e.g., users 102a, 102b, 102c), user groups (e.g., user group 102), and merchants (e.g., one or more merchants associated with the merchant servers 140). For example, account information 194 may include private financial information of each member of the user group 102 and each merchant associated with the one or more merchant servers 140, such as one or more account numbers, passwords, credit card information, banking information, or other types of financial information, which may be used to facilitate online financial transactions between the user group 102 and the one or more merchants associated with the merchant servers 140. In various aspects, the methods and systems described herein may be modified to accommodate users, user groups, and/or merchants that may or may not be associated with at least one existing user account, user group account, and/or merchant account, respectively.

In one implementation, the user group 102 and/or each member thereof may have identity attributes stored with the service provider server 180, and each member of the user group 102 may have credentials to authenticate or verify identity with the service provider server 180. User attributes may include personal information and banking information, as previously described. In various implementations, the user attributes may be passed to the service provider server 180 as part of a group purchase and/or payment request, and the user attributes may be utilized by the service provider server 180 to associate the user group 102 with one or more particular user accounts maintained by the service provider server 180.

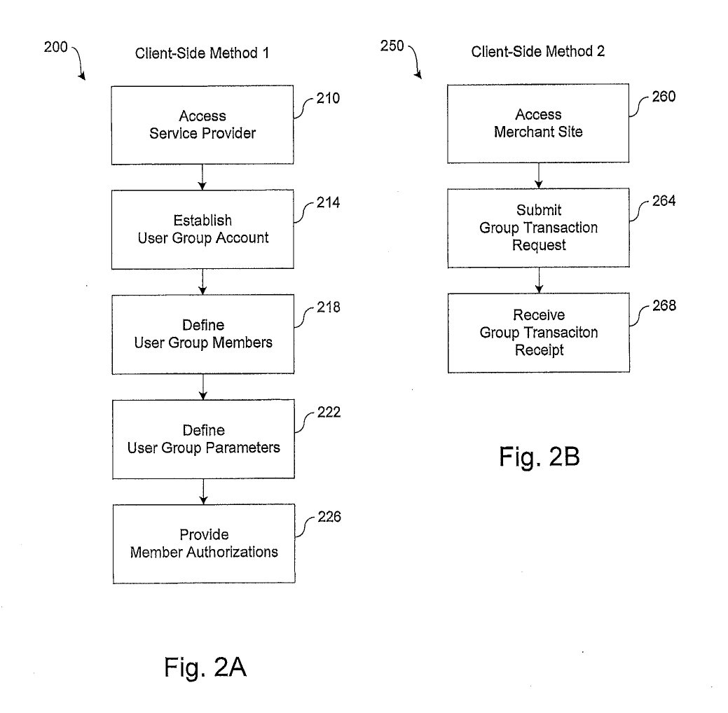

FIG. 2A shows one embodiment of a method 200 for facilitating a client-side online payment sharing transaction with the service provider server 180 in reference to the user group 102 and the one or more client devices 120. In one aspect, as described herein, the service application 182 allows the service provider server 180 to process online financial transactions and share payment for purchases from the one or more merchant servers 140 between members of the user group 102. As such, in various implementations, online invoices, bills, and payments for products and/or services may be shared between one or more members of the user group 102.

In one implementation, one or more members of the user group 102 may utilize the user interface application 122 on the client device 120 to access the at least one service provider server 180 via the network 160 (block 210). Next, the one or more members of the user group 102 establishes a user group account with the service provider server (block 214) and defines each user group member for the user group account (block 218). In one aspect, each member of the user group 102 provides personal and financial information to the service provider server 180 to establish the user group account. In another aspect, each of the members of the user group 102 may have separate user accounts with the service provider server 180, and these separate user accounts may be linked to the user group account.

Next, the one or more members of the user group 102 defines user group parameters for each user group member of the user group 102 for the user group account (block 222). In one aspect, the user group parameters may include user account numbers for each of the user group members that may be used to fund shared payments. In another aspect, the user group parameters may include a predetermined amount, portion, or percentage that each user group members is set to contribute towards a shared payment. In various other aspects, the user group parameters may include personal identification information for verifying the identity of each member that belongs to the user group 102.

Next, each member of the user group 102 provides member authorizations for shared payments with the user group account (block 226). In various aspects, each of the member authorizations may include information related to one or more types of authorized payments and purchases, dates and times of authorized payments and purchases, etc. that are authorized with the user group account. For example, if a plurality of user members are roommates and each member authorized the shared expense of rental housing, then the user group account may be authorized to directly and/or automatically debit a portion or percentage of rent funds from each member's separate user account based on predetermined parameters, such as a particular time and day, for the full payment of the rent for the rental housing. In another example, if a plurality of user members plan a group vacation and authorized the shared expense of the group vacation, then the user group account may be authorized to directly and/or automatically debit a portion or percentage of vacation funds from each member's separate user account based on predetermined parameters, such as a particular time and day, for the full payment of the expense of the group vacation.

In one implementation, the user group account may be separate from any one of the user accounts of each member of the user group, which may be separately fundable from each of the user group accounts of the user group members. This allows group funds to be collected prior to payments of invoices, bills, and/or purchases. In another implementation, the user group account may comprise a temporary holding account that is fundable from each of the user group accounts of the user group members, but is eliminated once a payment is completed. In still another implementation, the user group account may comprise a list of user group members and user accounts associated to each user group member, wherein funds may be directly and/or automatically debited from each of the member's user accounts at the time that payment is due.

FIG. 2B shows one embodiment of a method 250 for facilitating a client-side online payment sharing transaction with the service provider server 180 in reference to the user group 102 and the client device 120. In one aspect, the method 250 involves one or more members of the user group 102 making an online purchase and/or payment for products and/or services on behalf of the user group 102, which may be referred to as a group transaction request provided to the service provider server 180 for processing.

In one implementation, one or more members of the user group 102 may utilize the user interface application 122 on the client device 120 to access a merchant site of at least one of the merchant servers 140 via the network 160 (block 260). Next, the one or more members of the user group 102 submits a group transaction request to the at least one merchant server 140 via the network 160 for processing by the service provider server 180 (block 264). Next, after processing of the group transaction request, the one or more members of the user group 102 receives a group transaction receipt from the service provider server 180 via the at least one merchant server 140 (block 268). As described herein, the service provider server 180 utilizes the service application 182 to process online financial transactions, such as the group transaction request, and share payment for the group transaction request between members of the user group 102. As such, online invoices, bills, and payments for products and/or services may be shared between one or more members of the user group 102.

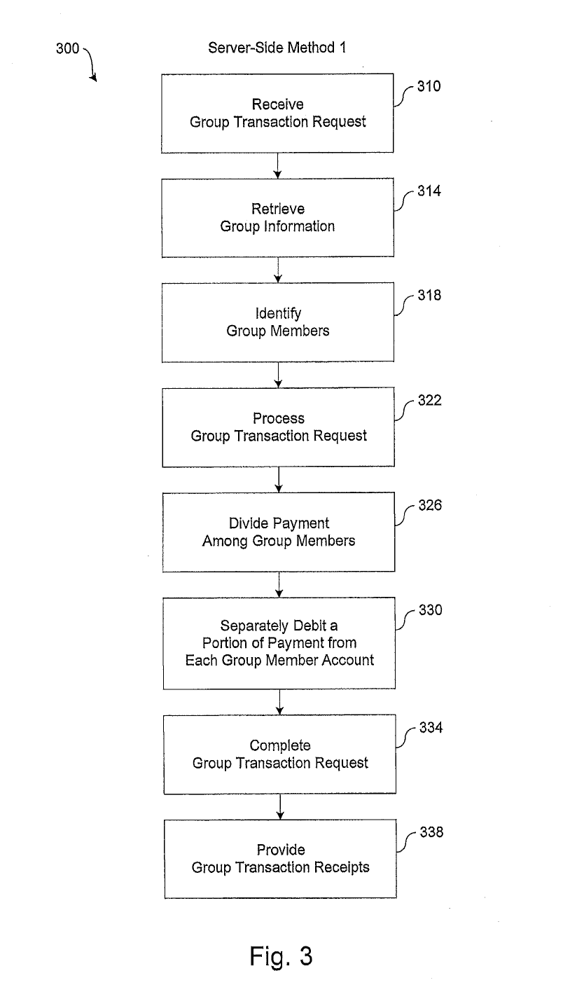

FIG. 3 shows one embodiment of a method 300 for facilitating a server-side online payment sharing transaction with the service provider server 180 in reference to the user group 102 and the client device 120. In various aspects, the service provider server 180 is adapted to receive and process various types of group transaction requests (e.g., bill payment requests, invoice payment requests, expense payment requests, group purchase requests, etc.) via the network 160 between one or more members of the user group 102 and merchant servers 140. As described herein, the service provider server 180 is adapted to split, share, or divide the payments between members of the user group 102 based on user parameters.

In one implementation, the service provider server 180 is adapted to receive a group transaction request from the user group 102 via the network 160 (block 310). In various implementations, the group transaction request may be received from any member of the user group 102 via the client device 120 over the network 160.

Next, the service provider server 180 is adapted to retrieve group information of each member of the user group 102 (block 314) and identify each group member of the user group 102 (block 318). In various implementations, the group information for the user group 102 and/or each member thereof may be stored and/or archived as account information 194 in the account database 192 of the service provider server 180. The group information may include or at least reference user group parameters including user identity information and/or user account numbers for each member of the user group 102 that may be utilized to fund shared payments, bills, expenses, invoices, etc. The user group parameters may include information related to a predetermined amount, portion or percentage that each user group member may be set to contribute towards a shared payment and/or purchase. The user group parameters may include personal identification information for verifying the identity of each member that belongs to the user group 102.

Next, the service provider server 180 is adapted to process the received group purchase request based on the information passed with the request (block 322). In various aspects, each of the member of the user group 102 may provide payment and purchase authorizations for user group related transaction requests. In one aspect, these member authorizations may include pre-authorization agreements for one or more types of payments and/or purchases, such as a rent payment, a utility bill, a shared vacation expense, etc. In another aspect, the service provider server 180 may seek direct authorizations from each member before directly and/or automatically debiting each member's account for the shared payments, purchases, and/or expenses. For example, the service provider server 180 may request authorization from each member of the user group 102 via email and wait for response via email from each member prior to directly and/or automatically debiting each member's account. In one aspect, this allows each member to approve the shared expense prior to payment.

Next, the service provider server 180 is adapted to divide, split, or share the payment for the group purchase request between each member of the user group 102 (block 326). For example, as described herein, payments and/or expenses are shared among each member of the user group 102 according to a predetermined amount, portion or percentage that each user group member may be set to contribute towards the shared payments and/or expenses.

Next, the service provider server 180 is adapted to separately debit an amount, portion, or percentage of the payment, purchase, and/or expense from each member of the user group 102 (block 330). In various implementations, the shared payment, purchase, and/or expense may be directly and/or automatically debited from the user group account or each member's own personal user account based on authorization parameters as provided by each member in the group information. In one aspect, the user group account may comprise a list of user group members and user accounts associated to each user group member, wherein funds may be separately debited from each of the member's accounts for the payment. In another aspect, the user group account may be separate from any one of the member's accounts of the user group, which may be separately fundable from each of the user group accounts of the user group members. As such, the service provider server 180 is adapted to fund the group user account from each member's account of the user group 102. In still another aspect, the user group account may comprise a temporary holding account that is fundable from each of the user group accounts of the user group members, but is eliminated once a payment is completed. As such, the service provider server 180 is adapted to fund the temporary holding account from each member's account of the user group 102.

Next, the service provider server 180 is adapted to complete the group transaction request (block 334). In various aspects, completing the group transaction request may include the service provider server 180 providing payment to the merchant on behalf of the user group 102 and/or verifying the exchange of funds for the payment between accounts through validation, delivery, and settlement. For example, the service provider server 180 is adapted to credit at least one merchant account related to the merchant server 140 an amount for the payment as debited from each user group member's account. The at least one merchant account may be with the service provider server 180, which may be stored in the account database 192. Alternatively, the at least one merchant account may be established with some other financial institution. As such, the service provider server 180 is adapted to submit the funds debited from each user group member's account to the merchant's financial institution for credit to the merchant's account therewith.

Next, the service provider server 180 is adapted to provide a transaction receipt for the completed group transaction request to each member of the user group 102 and/or the merchant via the merchant device 140 (block 338). For example, the service provider server 180 may provide a printable receipt to each member of the user group 102 via email and/or post payment information to each member's account in the account database 192, which may be accessible to each member via the network 160. In another example, the service provider server 180 may provide a printable receipt to the merchant and/or merchant server 140 via email and/or post payment information to the merchant's account in the account database 192, which may be accessible to the merchant via the network 160.

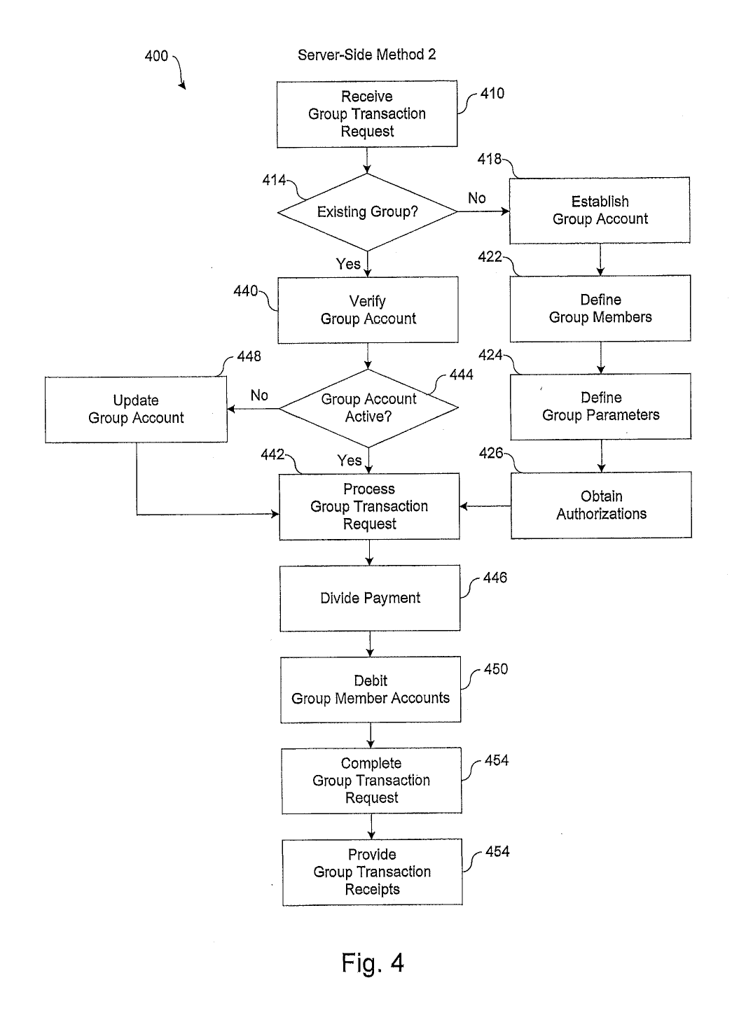

FIG. 4 shows one embodiment of a method 400 for facilitating a server-side online payment sharing transaction with the service provider server 180 in reference to the user group 102 and the client device 120. Similar to method 300 of FIG. 3, the service provider server 180 is adapted to receive and process various types of group transaction requests via the network 160. As such, the service provider server 180 is adapted to split, share, or divide payments, purchases, and/or expenses between each member of the user group 102.

In one implementation, the service provider server 180 is adapted to receive a group transaction request from the user group 102 via the network 160 (block 410). In various implementations, the group transaction request may be received over the network 160 from at least one member of the user group 102 via at least one client device 120.

Next, the service provider server 180 is adapted to review information passed with the group transaction request and determine if the group transaction request refers to an exiting user group 102 (block 414). If yes, then the method 400 proceeds to verify the group account indicated in the group transaction request (block 440). In one aspect, this verification may include verifying the identity of each member associated with the user group account by, for example, retrieving group information of each member of the user group account and identifying each group member of the user group account. Next, the service provider server 180 is adapted to determine if the user group account is active. In various aspects, this may include determining when the last group transaction request was completed and/or if the user group account has expired based on account information 194 retrieved from the account database 192 related to the user group account. Next, if the account is not active, then the service provider server 180 is adapted to update the user group account. In various aspects, this may include updating group parameters of each member of the use group 102 based on information passed with the group transaction request and/or extending an expiration date of the user group account based on information passed with the group transaction request. Next, after updating the account or determining that the user group account is active, then the service provider server 180 is adapted to process the group transaction request based on the information passed with the request (block 442).

Otherwise, if the user group 102 identified in the group transaction request is not an existing user group having a user group account, then the service provider server 180 is adapted to establish a user group account (block 418), define each user group member for the user group account (block 422), define user group parameters for each user group member (block 424), and obtain member authorizations for shared payments with the user group account (block 426), for example, as described in reference to FIG. 2. Then, the service provider server 180 is adapted to process the group transaction request based on the information passed with the request (block 442).

In one implementation, processing the group transaction request may include retrieving group information of each member of the user group 102 and/or identifying each group member of the user group 102. In another implementation, processing the group transaction request may include locating user accounts for each of the members of the user group 102 and reviewing group parameters for each member of the user group 102.

Next, the service provider server 180 is adapted to divide, split, or share the payment for the group purchase request between each member of the user group 102 (block 446). As described herein, payments and/or expenses may be shared among each member of the user group 102 according to a predetermined amount, portion or percentage that each user group member may be set to contribute towards the shared payments and/or expenses.

Next, the service provider server 180 is adapted to separately debit an amount, portion, or percentage of the payment, purchase, and/or expense from each member of the user group 102 (block 450). In various implementations, the shared payment, purchase, and/or expense may be directly and/or automatically debited from the user group account or each member's own personal user account based on authorization parameters as provided by each member in the group information. In one aspect, the user group account may comprise a list of members for the user group account and user accounts associated with each member of the user group account, wherein funds may be separately debited from each member's accounts for the payment. In another aspect, the user group account may be separate from any one of the member's user accounts and separately fundable from each member's user accounts. In still another aspect, the user group account may comprise a temporary holding account that is fundable from each member's user accounts and then closed once a payment is completed. Next, in a similar manner as described in reference to FIG. 3, the service provider server 180 is adapted to complete the group transaction request (block 454) and provide at least one group transaction receipt for the completed group transaction request to each member of the user group account and/or the merchant (block 458).

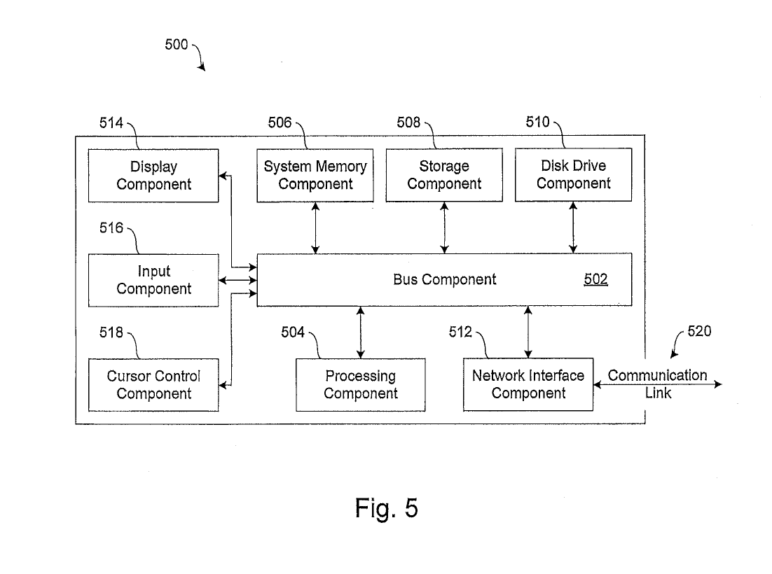

FIG. 5 is a block diagram of a computer system 500 suitable for implementing one or more embodiments of the present disclosure, including the client device 120, the one or more merchant devices 140, and the service provider device 180. In various implementations, the client device 140 may comprise a personal computing device capable of communicating with the network 160, such as a personal computer, laptop, cell phone, PDA, etc., the one or more merchant devices 140 may comprise a network computing device, such as a network server, and the service provider device 180 may comprise a network computing device, such as a network server. Hence, it should be appreciated that each of the devices 120, 140, 180 may be implemented as computer system 500 in a manner as follows.

In accordance with various embodiments of the present disclosure, computer system 500, such as a personal computer and/or a network server, includes a bus 502 or other communication mechanism for communicating information, which interconnects subsystems and components, such as processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., CRT or LCD), input component 516 (e.g., keyboard), and cursor control component 518 (e.g., mouse or trackball). In one implementation, disk drive component 510 may comprise a database having one or more disk drive components.

In accordance with embodiments of the present disclosure, computer system 500 performs specific operations by processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of or in combination with software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 520 (e.g., network 160 of FIG. 1, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A computer system for facilitating group transactions, the computer system comprising:
a network interface component;
a storage component storing account information; and
a processing component configured to:
in response to receiving a group transaction request initiated by a first user, identify a particular group corresponding to the group transaction request, the group transaction request being received via the network interface from a requesting user device;
determine a plurality of users corresponding to the particular group;
determine, based on the account information, authorization requirements for each of the plurality of users;
in response to determining that the authorization requirements for one or more users of the plurality of users requires manual consent, causing respective user interfaces to display requests for manual consent on respective user devices corresponding to the one or more users;
in response to determining that the authorization requirements for each of the plurality of users have been satisfied, apportioning the group transaction request among the plurality of users;
causing transactions from respective accounts corresponding to each of the plurality of users in accordance with the apportioning of the group transaction request; and
causing user interfaces at each of the plurality of users to display confirmation of the group transaction.

2. The computer system of claim 1, wherein the group transaction request comprises a merchant identifier and the merchant identifier comprises banking information.

3. The computer system of claim 1, wherein the particular group is associated with user identity information, user account numbers, and a predetermined contribution to the group transaction request for each of the plurality of users.

4. The computer system of claim 1, wherein the particular group is associated with a group identifier.

5. The computer system of claim 4, wherein the group identifier comprises personal information related to each of the plurality of users.

6. The computer system of claim 1, wherein the account information comprises personal and financial information for each of the plurality of users.

7. The computer system of claim 1, wherein the authorization requirements relate to dates and times that funds can be debited from a user account.

8. The system of claim 1, wherein the processing component is further configured to:
establish a group account; and
eliminate the group account once the group transaction request is processed.

9. The system of claim 8, wherein the group account comprises separate user accounts for each of the plurality of users.

10. A method for facilitating group transactions comprising:
electronically receiving a group transaction request from a first user;
identifying a particular group corresponding to the group transaction request;
identifying each member in the particular group;
seeking payment authorization from each member in the particular group;
after receiving payment authorization from each member in the particular group, debiting a portion of the group transaction request from an account of each member; and
crediting a merchant account with an amount corresponding to a total amount debited from each member's account.

11. The method of claim 10, wherein the group transaction request comprises a merchant identifier and the merchant identifier comprises banking information.

12. The method of claim 10, further comprising retrieving information of each member in the particular group.

13. The method of claim 12, wherein the information comprises a predetermined amount that each member has set to contribute to the group transaction request.

14. The method of claim 10, further comprising providing a receipt for the group transaction request to each member in the particular group.

15. The method of claim 10, further comprising:
establishing a group account; and
eliminating the group account once the group transaction request is processed.

16. A non-transitory machine-readable medium having stored thereon machine-readable instructions executable to cause a machine to perform operations comprising:
establishing a user group account;
defining each member in the user group account;
defining user group parameters for each member in the user group account;
electronically receiving a group transaction request from a first user;
obtaining authorizations from each member in the user group account for the group transaction request; and
debiting an amount associated with the group transaction request from the user group account.

17. The non-transitory machine-readable medium of claim 16, wherein the group transaction request comprises a merchant identifier and the merchant identifier comprises banking information.

18. The non-transitory machine-readable medium of claim 16, wherein the group transaction request comprises a group identifier.

19. The non-transitory machine-readable medium of claim 16, wherein the user group parameters comprise user identity information, user account numbers, and a predetermined contribution to the group transaction request for each member in the user group account.

20. The non-transitory machine-readable medium of claim 16, wherein the operations further comprise eliminating the user group account once the group transaction request is processed.
